(19) United States
(12) Patent Application Publication
(10) Pub. No.: US 2008/0252793 A1
(43) Pub. Date: Oct. 16, 2008

(54) MEDIA CONTROLLER WITH ANTI-MICROBIAL AND ANTI-FUNGAL CAPABILITY

(76) Inventors: Ho-Yeol CHOI, Seoul (KR); Robert Harry Willison, Lebanon, OH (US); IL-Kwon Sohn, Daegu-si (KR); Weon-Mok Lee, Daegu-si (KR)

Correspondence Address: SUGHRUE MION, PLLC, 2100 PENNSYLVANIA AVENUE, N.W., SUITE 800, WASHINGTON, DC, 20037, US

(21) Appl. No.: 11/734,343

(22) Filed: Apr. 12, 2007

(51) Int. Cl. H04N 5/44

(52) U.S. Cl. 348/734; 348/E05.103

(57) ABSTRACT

A media controller with anti-microbial and anti-fungal capability is provided. The media controller not only receives and outputs an audio signal provided from an external media device such as a television or a recorded media player and controls the external media device, but also outputs the sound or audio signal received from the media device as audible sound. The media controller is capable of having an antimicrobial, antifungal, or antibacterial agent used in hospitals coated on an external surface thereof to provide anti-microbial and anti-fungal properties when a user comes into contact with the media controller.

### BACKGROUND OF THE INVENTION

1. Field of the Invention

The present invention relates to a media controller that receives and outputs an audio signal provided from a separate media device such as a television or a recorded media player and controls the separate media device, and particularly, to the media controller capable of having an anti-microbial, anti-fungal, or anti-bacterial agent coated on an external case thereof to provide it with anti-microbial and anti-fungal properties.

2. Description of the Related Art

Hospitals and medical centers usually have signaling devices such as nurse-call devices installed for the convenience of patients requiring bed-ridden treatment for a predetermined duration. Audio-visual media such as televisions are also installed in hospitals and medical centers, respectively for each patient bed. Such televisions are respectively connected via wire to a pillow speaker, permitting patients to listen to the television audio signal and control volume through the pillow speaker.

Because hospitals generally contain lots of bacteria and patients admitted to hospitals usually have a low level of immunity, there is a high probability of bacterial infection of patients.

A pillow speaker, which is sequentially touched and used by many patients, generally has an outer case made of a synthetic resin. Due to its use by many patients, the outer case of the pillow speaker provides an environment conducive to bacterial habitation. Thus, it provides a route for patients to be infected by bacteria.

Also, because sterilizing a digital device such as a pillow speaker is not easy, pillow speakers cannot be maintained at the same level of sterility as other medical devices.

### SUMMARY OF THE INVENTION

Accordingly, the present invention is directed to a media controller with anti-microbial and anti-fungal capability that substantially obviates one or more problems due to limitations and disadvantages of the related art.

An object of the present invention is to provide a media controller that receives and outputs an audio signal provided from a separate media device such as a television or a recorded media player and controls the separate media device, and particularly to the media controller capable of having an anti-microbial, anti-fungal, or anti-bacterial agent coated on an external surface thereof to provide it with anti-microbial and anti-fungal properties.

The media controller of the present invention may be a remote controller which is separated from a media device and control the media device. The media controller may be connected by wire or wirelessly to the separate media device. The separate media device may be a television, a set-top box, a video tape recorder (VTR), a digital versatile disk (DVD) player, a compact disk (CD) player, a record player, or other audio/visual device.

According to other embodiments, the media controller may include a speaker that outputs audio and sound signals from the separate media device, as well as a remote control function, and the remote controller and the speaker may be integrated within a single external case.

The media controller including the speaker may be applied as a pillow speaker functioning as a remote controller-cum-speaker for televisions installed in hospitals and other medical centers.

The media controller may output a predetermined signal for controlling the separate media device to the media device, and the controlling signal may differ according to the separate media device. For example, if the separate media device is a television, the controlling signal may include power on/off, channel section and switching, volume output control, an on-screen display (OSD) type control menu, and other functions for controlling the media device.

The media controller may prevent the habitation and proliferation of hospital bacteria and mold (hereinafter called “germs”) in order to prevent infection of patients from the germs at the source. To achieve this, an anti-bacterial material is coated on the outer case of the media controller. The anti-bacterial material may be an inorganic/organic anti-bacterial material.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, there is provided a media controller with anti-microbial and anti-fungal capability that is connected by wire or wirelessly to a separate media device, the media controller including a speaker, an input, a controller, an interface, and an outer case with an anti-bacterial member.

In order to control the separate media device, when various control commands from a user are received through the input, the controller generates control signals for controlling the separate media device according to the control commands inputted in the input by the user.

The interface relays the control signals from the controller through a wire or wirelessly to the separate media device, receives audio signals sent from the media device according to the relayed control signals, and provides the audio signals to the speaker.

The speaker outputs the audio signals provided by the interface as an audible sound.

Here, the separate media device may be one of a television, set-top box, VTR, DVD player, CD player, and record player.

The anti-bacterial member provided on the outer case according to the present invention may be a coated layer that is coated on the outer surface of the outer case with a coating liquid containing anti-bacterial material.

The anti-bacterial member may be a chemically coated layer formed by covalent bond between the surface of the outer case and a fluoride organic silane compound having 3-31 fluorides(F)-substituted C1-15. This anti-bacterial member may be a carrier of anti-bacterial material.

Additionally, the anti-bacterial material may be one or more selected from the group consisting of silver (Ag), copper (Cu), zinc (Zn), manganese (Mn), and ions thereof.

In another aspect of the present invention, there is provided an anti-bacterial member forming an anti-bacterial coating on the entire outer surface of the outer case of a media controller, of which the coated anti-bacterial member is stronger in areas more frequently contacted by users, such as keypads.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a media system including a media controller according to an embodiment of the present invention;

FIG. 2 is a block diagram of a media controller according to an embodiment of the present invention; and

FIG. 3 is a perspective view of a media controller according to an embodiment of the present invention.

### DETAILED DESCRIPTION OF THE INVENTION

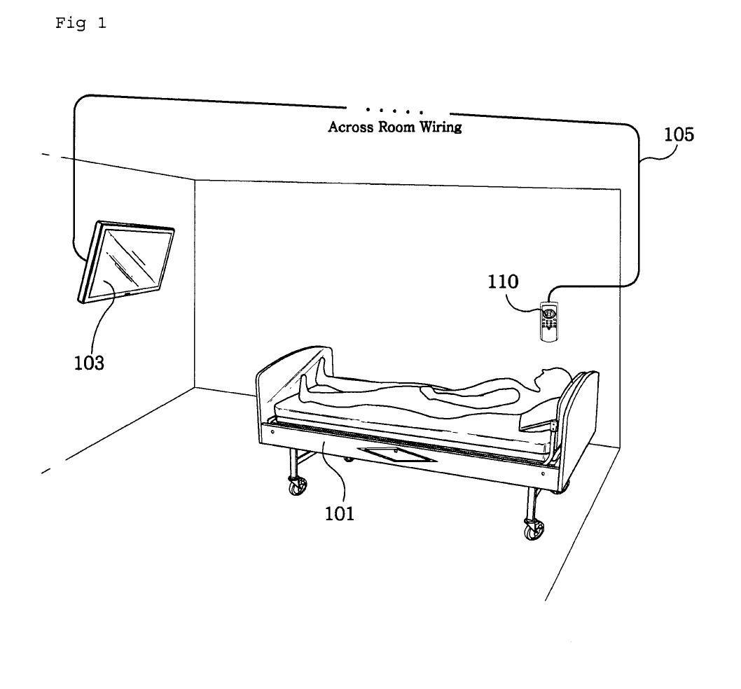

Reference will now be made in detail to the preferred embodiments of the present invention, examples of which are illustrated in FIGS. 1 through 3. Wherever possible, the same reference numbers will be used throughout the drawings to refer to the same or like parts.

FIG. 1 is a perspective view of a media system including a media controller according to an embodiment of the present invention. FIG. 1 shows a schematic view of a pillow speaker connected by wire to a television.

A pillow speaker is connected to a television installed for each hospital bed in a hospital room. Referring to FIG. 1, a pillow speaker 110 is positioned in an area near where a patient lies on a bed 101, and is connected to a television 103 at a separate end of the bed 101 through a preinstalled cable 105 built into the wall or attached to the wall surface.

While lying on the bed 101, a user uses the pillow speaker 110 to switch power to the television (which is installed within view) on or off and switch channels to view television broadcasts, and listen to sound emitted through the pillow speaker 110. Also, the user uses the pillow speaker 110 to adjust the volume of voice or audio signal from the television 103.

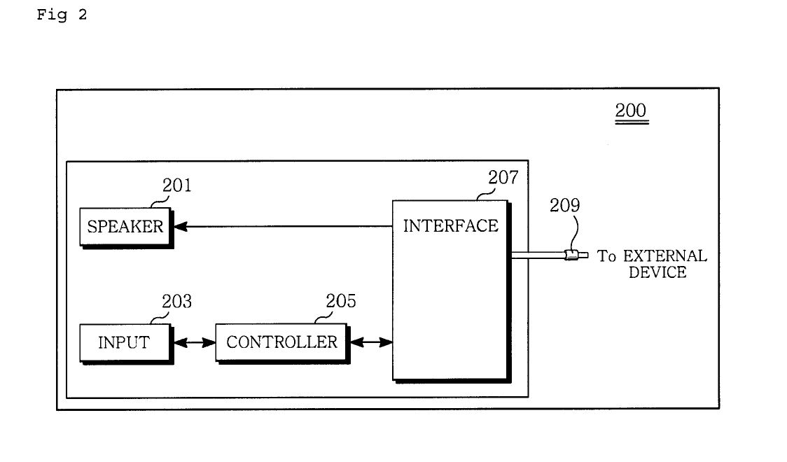

Below, a description of the hardware configuration and function of a media controller according to the present invention will be given, with reference to FIG. 2. As a block diagram of a media controller according to an embodiment of the present invention, FIG. 2 will be described based on a pillow speaker.

Referring to FIG. 2, a pillow speaker 200 includes a speaker 201, an input 203, a controller 205, an interface 207, and a jack 209 electrically connected to the interface 207. The pillow speaker 200 in FIG. 2 corresponds to the pillow speaker 100 in FIG. 1, and may be described in the same manner.

The interface 207 is connected to the television 103 in FIG. 1 through the jack 209, receives sound and audio signals transmitted by the television 103, and relays predetermined control signals generated by the controller 205 to the television 103. While the interface 207 may be a wired or wireless interface, the interface 207 shown in FIG. 2 and applicable in FIG. 1 is a wired interface.

The speaker 201 outputs sound and audio signals received through the interface 207 in the form of audible sound.

The input 203 is coupled to an outer case of the pillow speaker 200, receives predetermined control commands for controlling the television 103 from a user, and transmits the commands to the controller 205. The controller 205 generates control signals corresponding to the control commands transferred from the input 203 and relays the control signals to the interface 207. The control signals are relayed to the television 103 through the interface 207, so that the television 103 operates in accordance with the control commands made by the user.

Any other media controller of the present invention may be formed in configurations including that described above.

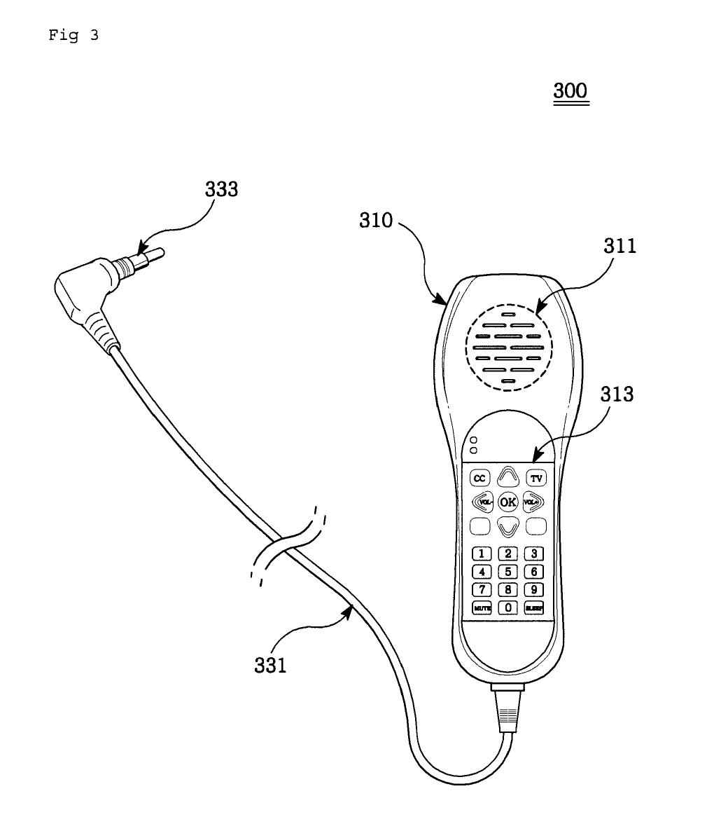

Referring to FIG. 3, the anti-bacterial function of a media controller will be described. FIG. 3 is a perspective view of a media controller according to an embodiment of the present invention.

A pillow speaker 300 shown in FIG. 3 corresponds to the pillow speaker 100 in FIG. 1, and may be described in the same way.

Referring to FIG. 3, a pillow speaker 300 includes an outer case 310, and a lead wire 331 and a connecting jack 333. The speaker 201, the input 203, the controller 205, and the interface 207 in FIG. 2 are built inside the outer case 310.

The outer case 310 may be formed of a metal or synthetic resin material and have the shape of a peanut; however, its shape is not limited to the one depicted.

The outer case 310 has speaker through-holes 311 and a keypad formed therein/thereon.

The speaker through-holes 311 are for emitting sound and audio signals from the speaker 201 in FIG. 2, and are not limited to the slit-shapes shown in FIG. 3. The keypad 313 is connected to the input 203. Thus, the input 203 is not directly exposed to the outside, giving the pillow speaker 300 water resistance.

The lead wire 331 is electrically connected to an electronic substrate installed within the outer case 310, and has the connecting jack 333 provided on its end portion to connect to the cable 105 that is connected to the television 103 in FIG. 1.

In alternate embodiments, the pillow speaker may have portions that house the keypad corresponding to the input, and the speaker through-holes corresponding to the speaker, respectively, formed in separate outer cases, where the two outer cases are electrically connected with a predetermined cable.

By forming the speaker through-holes 311 and the keypad 313 on the outer surface of the outer case 310, not only is the pillow speaker 300 able to receive command inputs through contact by a user, the pillow speaker 300 can also output sound and audio to the user (who is within range of contact). Therefore, the outer case 310 is inevitably disposed within contact of many patients so that it can transmit germs between patients.

However, the outer case 310 of the pillow speaker 300 according to the present invention is anti-bacteria treated, so that it can be disinfected to prevent habitation and growth of bacteria. Accordingly, even when the pillow speaker 300 is exposed to many patients, its outer case 310 will not provide a transmissive route for germs.

A base material for the outer case 310 may be a metal or synthetic resin. In the case of the latter, the base material may be one of Polyvinyl chloride, Poly ethylene, Low density polyethylene, High density poly ethylene, Polypropylene, Polystylene, Polyurethane, Acrylonitrile-Butadiene-Styrene plastic, Ethylene viscosity alcohol, Polyethylene Terephthalate, Polyamide, Polycarbonate, Polyoxymethylene, Poly butylene terephthalate, Polymethylmethacrylate, NYLON, Polydimethylsiloxane, a copolymer of two or more thereof, or a transformed resin.

Below, a description of the anti-bacterial treatment of the outer case will be given.

Anti-bacterial material used for anti-bacterial treatment according to the present invention includes all anti-bacterial (which includes anti-fungal) material formed on the outer case 310. And an anti-bacterial member that is a coating layer of the anti-bacterial material may be formed on the surface of the outer case 310, and may be formed on the outer and/or inner surface thereof.

An example of the anti-bacterial member and a forming method thereof are described below.

First, the anti-bacterial member may be a coating layer, formed by applying a coating liquid including anti-bacterial material on the base synthetic resin material of the outer case 310.

The coating liquid is not limited to any particular type, and may be a commonly sold coating liquid that is mixed with an anti-bacterial material. The coating liquid may include high polymer binders to increase the adhesiveness to the outer case 310. Also, the coating liquid may be an inorganic material, including zeolite, phosphate, talc, hydroxyapatite, silica gel, and active carbon, etc.

Although there are no restrictions for the anti-bacterial material, it may include at least one of silver (Ag), copper (Cu), zinc (Zn), manganese (Mn), and ions from the same. The particle size of the material used may be in nanometers. The anti-bacterial and sterilizing effect of these metals or their ions occurs when they directly contact bacteria. Here, the bacteria of which cell walls are charged electrically couples to the metal or metal ions so that the corpuscle transmitting system of the bacteria is compromised. Thus, the cell membranes or the cell walls are damaged and the bacteria die, so that bacterial growth is prevented.

An example of a manufacturing method of the coating liquid including anti-bacterial material is described below. A solvent, ethanol having a diffused anti-bacterial material may be mixed together with a coating liquid with a high polymer, where the coating liquid is derived by: agitating a mixture of 10 g tetraethoxysilane, 3.3 g methyltrimethoxysilane, and 4.1 g heptadecafluorodecyltriethoxysilane for 30 minutes at 25° C., slowly adding 10.3 g 0.1 mol nitric acid solution, agitating for 2 hours at 25° C., thinning with 200 g 2-ethoxyethanol, and process reacting for 24 hours at 25° C.

Second, rather than applying a physical coating on the surface of the outer case 310, a chemical coating may be performed to form the anti-bacterial member.

That is, in a chemical coating method, the anti-bacterial member may be a coating layer chemically formed by covalent bond between a synthetic resin layer of the outer case 310 and a fluoride organic silane compound with a carbon number of 1 to 15, and the fluoride organic silane compound may substitute a portion or all of a number of hydrogen atoms in a range of 3 to 31 with fluoride. When the surface is coated with the fluoride-substituted organic silane compound, the surface of the outer case 310 becomes hydrophobic, so that its ability to adhere to bacteria is reduced, thereby shielding the outer case 310 with fluoride to prevent bacterial growth with the anti-bacterial properties of the fluoride.

When the fluoride organic silane compound is thus applied and chemically coated on the surface of the outer case 310 and the contact angle with water is measured, it can be seen that the contact angle has increased since before the chemical coating. The increase in contact angle with water signifies a shift from hydrophilicity to hydrophobicity, which means a decrease in the ability to adhere to bacteria.

The base material of the outer case 310 may be any material that is capable of covalent bonding with fluoride organic silane compound. The outer case 310 may be a synthetic resin which include a hydroxyl group on its surface, or generate the hydroxyl group by oxidizing a portion of the surface. For instance of the synthetic resin, a composition of polydimethylsilane (PDMS) group, that is, single PDMS or complex PDMS—for example, vinyl PDMS, a catalyst of platinum divinyltetramethyl-disiloxane, a tetramethyltetravinyl cyclotetrasiloxane controller, and hydrosilane pre-polymer may be used as well as polyhydroxistyrene, polyvinylalcohol, etc. Also, the above compositions may be blended or copolymerized with another synthetic resin.

In the case of a synthetic resin surface without hydroxyl group, the synthetic resin may be treated with O₂ plasma or UV ozone to oxidize the surface and generate hydroxyl group. That is, hydrogen carbonate on the surface of the synthetic resin is oxidized to form hydroxyl group (including oxygen radicals (—O), and hydroxyl radicals formed as an intermediate during the process of generating the hydroxyl group). With this method, even when hydroxyl group do not exist in the synthetic resin itself, they can be applied for a broader possibility of materials.

An example of the fluoride organic silane compound may be generated according to the chemical formula below.

Chemical Formula 1

R₄₋ₓSi(L)ₓ

In chemical formula 1 above, x is a whole number from 1-3, and L signifies hydroxyl group or a leaving group, where examples of the latter include alcoxy and halogen. R is one of alkyl group, alkene group, cycloalkene group, aril group which has 3-31 fluorides(F)-substituted C1-15.

The reactor depicted by L bonds covalently with hydroxyl group formed on the surface of the synthetic resin by a condensation reaction, so that the organic silane compound chemically bonds to a stamp, creating a permanent coupling.

Specific examples of the fluoride organic silane compound include the following with a portion or all hydrogen thereof replaced by fluoride: methyltrimetoxysilane, ethyltrimetoxysilane, normal profile trimethoxysilane, hexyltrimetoxysilane, octyltrimetoxysilane, decyltrimetoxysilane, phenyltrimetoxysilane, vinyltrimetoxysilane, methyltriethoxysilane, ethyltriethoxysilane, normal profile triethoxysilane, hexyltriethoxysilane, octyltriethoxysilane, decyltriethoxysilane, phenyltriethoxysilane, vinyltriethoxysilane, trifluoroprophyl trimethoxysilane, tridecafluorooctyltrimethoxysilane, heptadecafluorodecyltrimethoxysilane, dimethyldimethoxysilane, diethyldimethoxysilane, dimethyldiethoxysilane, diethyldiethoxysilane, diphenyldimethoxysilane and diphenyldiethoxysilane, and trimethylmethoxysilane, triethylmethoxysilane, trimethylethoxysilane and triethylethoxysilane. In the above, halogen may be used instead of alcoxy, due to its favorable reactive properties.

The anti-bacterial member may be made to include the above-described anti-bacterial material to increase its disinfecting capability. That is, when an outer case 310 is formed with the above fluoride organic silane compound covalently bonded thereto to form a chemically coated layer, it can be dipped in a solvent with an anti-bacterial material so that the anti-bacterial material permeates the chemically coated layer and remains therein. The chemically coated layer of fluoride organic silane compound is a structure with fine pores formed therein that allow nano-sized anti-bacterial material to be included therein.

In other embodiments of the present invention, the outer case 310 may be regionally treated with anti-bacterial material in consideration of regions that are frequently contacted by patients, or the anti-bacterial agent may be varied. For example, when manufacturing the outer case 310, the percentage of anti-bacterial material in an anti-bacterial coating may be increased for areas with high levels of contact with patients, or a secondary outer application or coating may be used to increase the level of bacterial resistance.

Also, in the above-described chemical coating method, by modifying the chemical coating reaction time of regions of the outer case 310 subject to frequent contact with patients, or altering the conditions of plasma or UV ozone processing, the percentage of anti-bacterial material that is chemically coated can be increased to provide a stronger resistance to bacteria.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A media controller connected through a wire or wirelessly to a separate media device, for controlling the separate media device, the media controller comprising:
a speaker for outputting an audio signal as audible sound;
an input for receiving various control commands to control the separate media device from a user;
a controller for controlling the separate media device through generating a control signal, according to the control commands received from the user through the input;
an interface for relaying the control signal generated by the controller through a wire or wirelessly to the separate media device, and receiving an audio signal sent by the separate media device according to the control signal and providing the audio signal to the speaker; and
an outer case on which an anti-bacterial member is formed.

2. The media controller of claim 1, wherein the separate media device is one of a television, set-top box, VTR (video tape recorder), DVD (digital versatile disk) player, CD (compact disk) player, and record player.

3. The media controller of claim 1, wherein the anti-bacterial member is a coating layer formed through coating a coating liquid including an anti-bacterial material on an outer surface of the outer case.
a coated layer formed on the outer surface of the outer case with a coating liquid including an anti-bacterial material.

4. The media controller of claims 3, wherein the anti-bacterial material is selected from at least one or more of Ag (silver), Cu (copper), Zn (zinc), Mn (manganese), and ions thereof.

5. The media controller of claim 1, wherein the anti-bacterial member is a chemically coated layer formed by covalent bond between a surface of the outer case and a fluoride organic silane compound having 3-31 fluorides(F)-substituted C1-15.

6. The media controller of claim 5, wherein the anti-bacterial member contains an anti-bacterial material.

7. The media controller of claims 6, wherein the anti-bacterial material is selected from at least one or more of Ag (silver), Cu (copper), Zn (zinc), Mn (manganese), and ions thereof.
